(19) United States
(12) Patent Application Publication
(10) Pub. No.: US 2004/0045620 A1
(43) Pub. Date: Mar. 11, 2004

(54) Method for extending the useable life of a polyamide pipe liner during use in a water-oil gas environment

(76) Inventor: David E. Kranbuehl, Harrison Avenue, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/432,525

(22) PCT Filed: Nov. 23, 2001
(86) PCT No.: PCT/US01/43837

(51) Int. Cl. F16L 11/00

(52) U.S. Cl. 138/139; 138/143

(57) ABSTRACT

Polyamide liners used in sub sea and over ground transport operations, such as nylon (11), are handled in a way which increases the rate of chain recombination relative to the competing process of chain scission. This enhances and increased the useable life of the polyamide liner by effectively reducing its rate of aging. The can be accomplished by incorporating a chain extender or desiccant into the polyamide liner, incorporating hydrophobic moieties or hydrophobic polymers into the polyamide liner, or by providing a sheath which is less permeable to water at the inner surface of the polyamide liner. Rejuvenation of the polyamide liner can also be achieved by heat treatment of the polyamide liner by hot air, hot oil or gas, or other hot liquids that are at a temperature above 1000° C. Rejuvenation may be enhanced by including a chain extender or desiccant to a hot oil, gas, or other liquid that is exposed to the polyamide liner.

### BACKGROUND OF THE INVENTION

1. Field of the Invention

The invention pertains to polyamide pipe liners used for the transport of oil or gas, and, more particularly, to a method for extending the useable life of a polyamide pipe liner that is used in a water-oil-gas environment.

2. Description of the Prior Art

Polyamide (PA) materials are used as liners for a gas-oil-water barrier in pipes used to transport gas, oil water and mixtures thereof. The normal practice in the industry is to extrude a nylon sheath in the shape of a continuous tube of a thickness ranging from several millimeters to several centimeters. This tube will be the principal barrier containing the fulid under flow. Sometimes a sacrificial layer several millimeters thick is extruded as a layer to protect the principal layer from mechanical friction (i.e., wear as it lubs against an internal metal carcass). The metal carcass prevents collapse of the piper from the sub-sea environment. A sacrificial layer may also be placed outside the principal PA layer to prevent friction wear of the principal layer with outer metal windings used to contain the often high internal pressures of the pipe which can be over 100 atmospheres.

Prior art also shows the measurement of the molecular weight of PA using witness coupons or taking small samples of the PA liner as a means for monitoring aging of the PA liner. Molecular weight has been shown to be correlated with the PA liner's performance mechanical properties. See, for example, U.S. Pat. No. 5,614,683 which is herein incorporated by reference.

However, there are no designs or operating procedures during use which are specifically designed to enhance the life of the PA liner other than the procedures and designs which are based on controlling the heat transfer and temperature of the liner material. These include mixing oil flow from the different feeder lines from various well heads or controlling the flow rate to lower the temperature in the pipe or the use of pipe supporting designs that reduce the temperature of the polyarnide liner by increasing the thermal cooling from the ocean water environment.

### SUMMARY OF THE INVENTION

It is an object of this invention to provide a method for increasing the useable lifetime of a PA pipe liner which reduces the rate of aging by increasing the rate of chain recombination relative to the competing process of chain scission.

The major aging process causing degradation of polyamide (PA) when used as a pipe liner for the transport of oil, gas, and/or water has been found to be the result of two competing processes. The first involves aging due to chain scission caused by hydrolysis. The second involves recombination of the broken bond unit due to aiidization. As a result of this finding, it is possible to both decrease the rate of aging by decreasing the rate of chain scission and/or by increasing the rate of recombination-amidization. This can be done by decreasing the presence of water diffusing into the polyamide or decreasing the amounts of dissolved wated in the polyamide through modification of the design of the pipe and the materials used, and/or operating procedures involving the use of additives placed in the pipe which decrease the rate of chain scission-hydrolysis or increase the rate of chain recombination.

### BRIEF DESCRIPTION OF THE DRAWINGS

The foregoing and other objects, aspects and advantages will be better understood from the following detailed description of the preferred embodiments of the invention with reference to the drawings, in which:

FIG. 1 is a graph showing the deterioration of molecular weight of a polyamide 11 sample over time at various temperatures in a 100% water environment for a relatively high molecular weight sample (77,000);

FIG. 2 is a graph showing an increase in the molecular weight of a polyamide 11 sample over time at various temperatures in a 100% water environment for a relatively low molecular weight sample (14,000);

FIG. 3 is a graph showing changes in molecular weight for a relatively high molecular weight polyamide 11 sample over time in different environments (e.g., dry oil (1% acid, dry), and oil-acid-water with increasing percentages of acid) at 115° C.);

FIG. 4 is a graph showing the changes in molecular weight of over time for a polyamide 11 sample over time which incorporates polyethylene glycol;

FIG. 5 is a cross-sectional view of a pipe typically used to transport oil or gas from a sub sea environment; and

FIG. 6 is a cross-sectional view of a pipe typically used to transport oil or gas above ground.

### DETAILED DESCRIPTION OF THE PREFERRED EMBODIMENTS OF THE INVENTION

Experiments have been conducted which demonstrate that the aging process of polyamide liner materials, particularly including but not limited to polyamide 11 (i.e., “nylon 11”) involves two competing process. We have shown that by controlling the ratio of the chain recombination rate relative to the chain scission rate, the life of a pipe liner used in a water-oil-gas environment can be extended and even rejuvenated. The methods of this invention extend the useable lifer of the pipe liner through design and materials selection in the fabrication of the pipe liner and through the methods involving use of additives and operating procedures in the field during use.

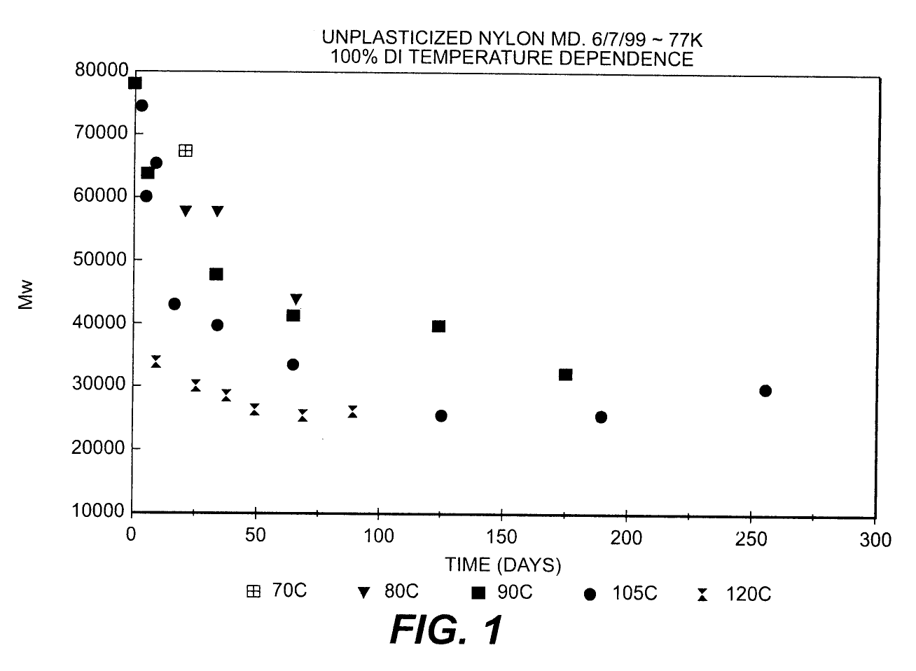

The following experimental molecular weight results are the basis for these methods of extending the useable life of polyamide (e.g., PA-11) barriers in pipes. FIG. 1 shows the change in molecular weight with time of a high molecular weight sample at various temperatures. The correlation of the molecular weight with mechanical performance properties and its decay during use to a lower value, marking the end of its useable life, has been previously described in U.S. Pat. No. 5,614,683.

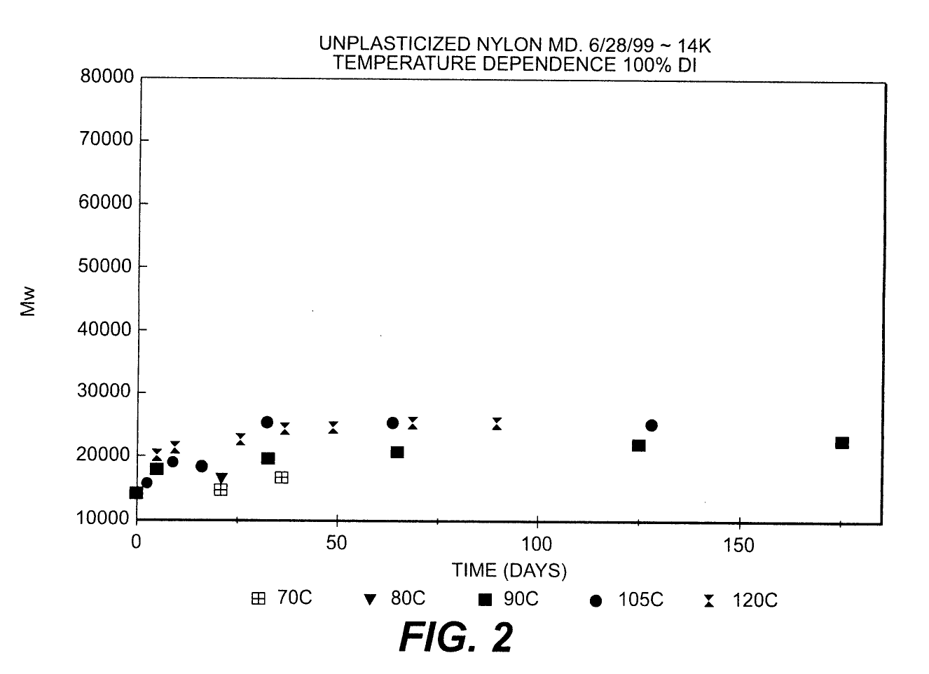

FIG. 2 shows the change in molecular weight of a lower molecular weight sample at these same temperatures and in the same environment. That is, in both FIGS. 1 and 2, the samples were stored in 100% water. In FIG. 1, the sample had a starting molecular weight of 77,000, and in FIG. 2, the sample had a starting molecular weight of 14,000. FIG. 2 in contrast to FIG. 1, shows that the molecular weight is increasing. Together, FIGS. 1 and 2 show the existence of processes which involve both chain scission and chain recombination during aging in a water-hydrolysis environment.

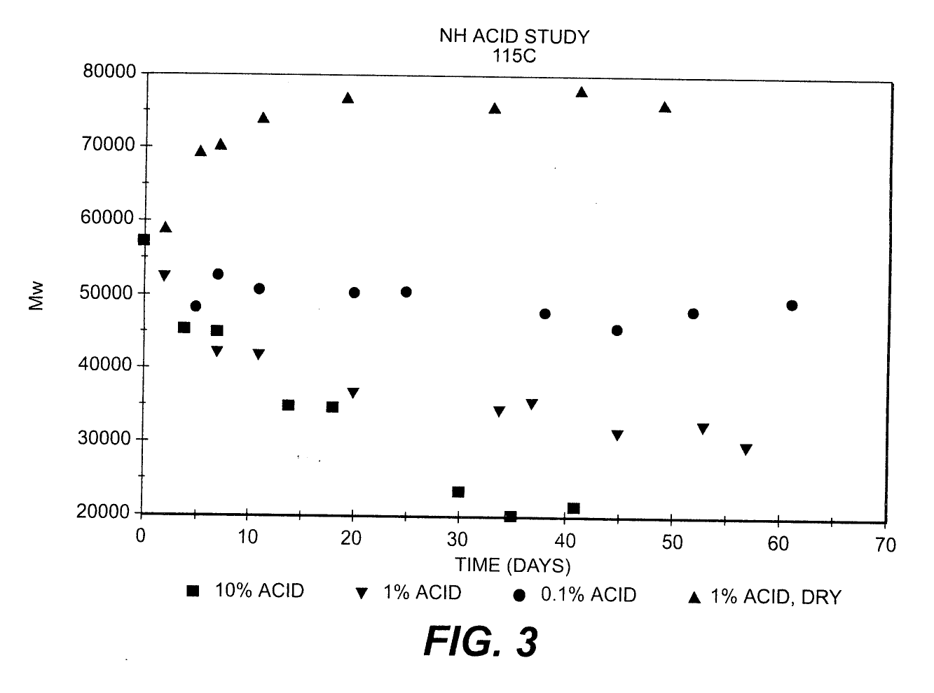

FIG. 3 shows the change in molecular weight of a relatively high molecular weight polyamide 11 sample in an oil-acid-water environment. FIG. 3 shows a much slower rate of decrease in the molecular weight when less acid-water is present. FIG. 3 also shows in a dry, oil environment, the molecular weight exhibits a small increase in its value over time.

Collectively, FIGS. 1-3 demonstrate that the molecular weight of a polyamide can either decrease or increase depending on the environment in which it is used. This is the basis for the method of extending the life expectancy of a pipe liner used in a water-oil-gas environment through manufacturing design and material modification or operating procedures during use, such as filling the pipe with a hot drying agent or hot dry oil.

Decreasing the amount of water present in the polyamide at any given temperature will increase the relative rate of chain recombination or polymerization and will decrease the relative rate of chain scission caused by hydrolysis. Decreasing the amount of water present in the polyamide tube liner can be controlled by several methods. One method involves constricting an inner sheath inside the principal piper liner which significantly reduces the diffusion of water in the polyamide barrier. Examples of suitable materials include fluorinated polymers such as tetrafluorinated polyethylene or polyvinyldifluoride. A second method involves modification to the polyamide structure which reduces water solubility in the polyamide. Examples of chemical modifications including adding moieties which reduce the concentration of water or solubility through copolymer, block polymer, graft polymer, polymer blends, or adding bulky or hydrophobic groups near the amide bond to create a modified polyamide chain. A third method involves use of additives in the pipe flow streams which complex and/or bind up the free water so that it does not diffuse into the polyamide sheath. Examples include dessicants, such as, but not limited to sodium sulfate, calcium chloride, and magnesium sulfate. A fourth method involves placing a drying agent in the pipe which reduces the water content in the polyamide sheath, and then allowing the pipe to heat up, as for example, by placing a hot dry oil in the pipe so the recombination rate can be made to exceed the rate of chain scission and the molecular weight of the polyamide (e.g., polyamide 11) can be increased. Alternatively, hot oil or hot oil with another liquid plus a dessicant, such as sodium sulfate, calcium chloride, magnesium sulfate could be used to fill the pipe, with the desiccant serving the function of reducing or eliminating water from the pipe liner. This last method will rejuvenate the life of the pipe liner while the first three decrease the rate of aging.

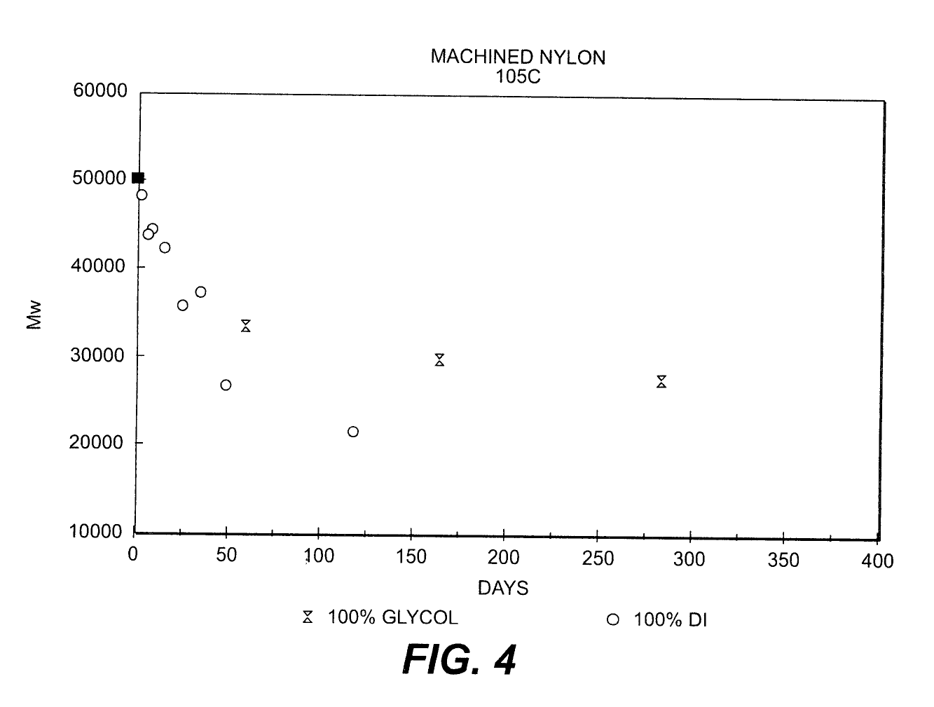

FIG. 4 shows that when the polyamide is exposed to ethylene glycol, a substance which is both a chain extender which can react with two polyamide chains tying them together with esterification, and also that can tie up water, the rate of degradation is decreased. This demonstrates the viability of an operating procedure which involves addition of a chain extender and/or water complexing agent such as ethylene glycol to the flow stream to decrease the rate of aging.

The methods described above can be used to extend the useable life and/or allow operation a higher temperature. As noted in the attached drawings, higher temperatures result in increased deterioration of the pipe liner; however, increased temperatures resulting from higher pumping rates result in a significant production rate and profit. By reducing the rate of polyamide deterioration using the methodologies described above, higher flow rates for pumping for extended period of times could be used which were not heretofor previously practicable.

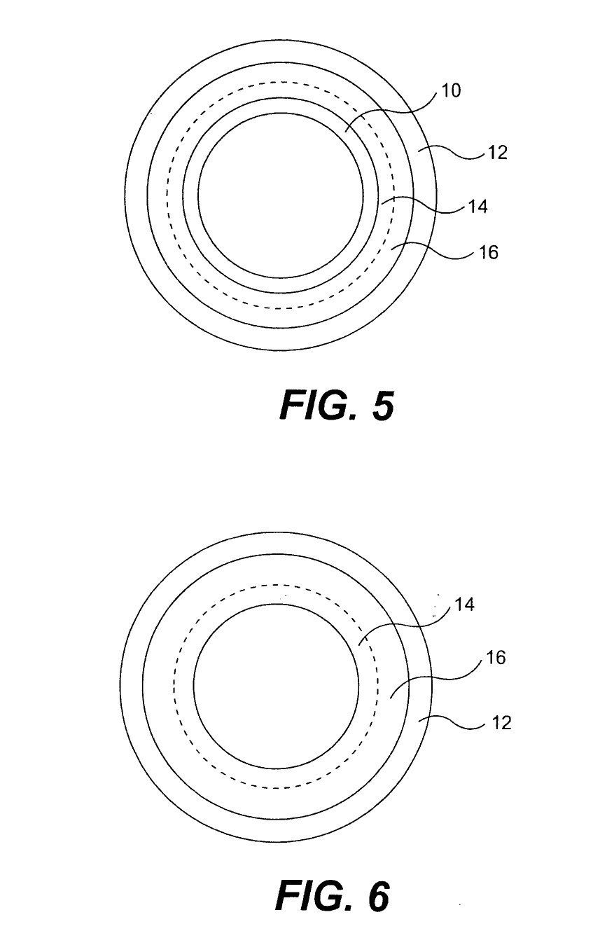

FIGS. 5 and 6 illustrate practical implementations of the claimed invention in pipes typically used to transport oil or gas in a sub sea environment or over ground, respectively.

In FIG. 5, there is an inner metal carcass 10 and an outer metal sheath 12. In FIG. 6, there is no inner metal carcass, but there is an outer metal sheath 12.

In one embodiment of the invention, a sheath 14 impermeable to water, but not gas or oil is adhered to the inner surface of the polyamide barrier layer 16. This sheath 14 can be extruded separately or simultaneously with the polyamide barrier layer 16. The sheath 14 serves the function of reducing the permeation of water in the fluid flow within the pipe into the polyamide barrier layer. Examples of suitable sheath materials include but are not limited to polyvinylchloride (PVC), polyvinyldifluoride (PVDF), polyethylene (PE), and polytetrafluoroethylene (PTFE). The polyamide barrier layer 16 acts as a barrier to the gas or oil being transported by the pipe. The sheath 14 and barrier layer 16 can each be on the order of several millimeters to several centimeters thick.

In another embodiment of the invention the sheath 14 is eliminated. Rather, in this embodiment, the polyamide barrier layer 16 is altered to be more resistant to water permeation, thereby reducing hydrolysis of the chemical backbone. In one aspect of this embodiment, a desiccant such as sodium sulfate, magnesium sulfate, or calcium chloride is incorporated into the polyamide barrier layer 16 during extrusion. Typically the quantity of desiccant would be less than 10% by weight of the extruded material. During pumping of gas or oil in the pipe, the desiccant in the barrier layer 16 would bind up the water which permeates from the gas or oil into the barrier layer, and thereby reduce chain scission. A variation on this aspect of the invention is to use a chain extender such as ethylene glycol which can both bind water and also join the ends of adjacent polyamide chains. In another aspect of this embodiment, the polyamide barrier layer 16 is a constructed as a copolymer such as a graft copolymer wherein hydrophobic side chains are covalently bonded to a backbone of a polyamide, a block copolymer wherein hydrophobic polymer chains are joined with the polyamide (e.g., alternating sections of the polymer would include polyamide and hydrophobic polymers), and polymer blends which include mixtures of hydrophobic polymers and polyamides. In the graft co-polymer variation, hydrophobic moieties such as halogens can be attached directly to the polyamide or to chains which are grafted to the polyamide. In the block co-polymer and polymer blend variations, polymers such as PVC, PVDF, and PTFE might be used.

It has also been demonstrated that rejuvenation of a polyamide liner material can be achieved. A piece of aged polyamide liner having a molecular weight between 24,000 and 28,000 was placed in a dry hot air environment for six days. At 24,000 to 28,000 molecular weight, the polyamide liner is generally replaced since at this molecular weight it is no longer elastic and becomes brittle. After six days at 100° C., the polyamide liner material was rejuvenated to a level of 35,000 molecular weight. A similar piece of aged polyamide liner was treated for six days at 150° C. and was rejuvenated to a higher molecular weight level. The high temperature may be driving off water that permeated into the polyamide as steam. Thus, it is contemplated that during operation of a sub sea gas or oil transport pipe or an above surface gas or oil transport pipe, the life expectancy of the polyamide barrier layer may be increased by periodic heat treatment such that moisture is driven out. For example, hot air can be directed through the pipe to rejuvenate the polyamide barrier layer, or a hot dry oil or gas at a temperature sufficient to drive out water can be directed though the pipe, or another dry liquid or a combination of gas or oil and another dry liquid at a temperature sufficient to drive out water can be directed through the pipe. To enhance the rejuvenation, a desiccant or chain extender could be incorporated into the hot dry liquid directed through the pipe. Preferably, the drying fluid will be of a sufficiently high heat capacity that it will allow adequate heating over the entire length of the polyamide liner when the fluid is injected at one end of the pipe (i.e., it will remain sufficiently warm to drive out water when it reaches the other end of the pipe). Alternatively, the pipe itself could include heating devices or hot air delivery devices used to heat a drying fluid and the polyamide material on a periodic basis.

While the invention has been described in terms of its preferred embodiments. Those skilled in the art will recognize that the invention can be practiced with modification within the spirit and scope of the appended claims.

I claim:

1. A pipe for the transport oil or gas, comprising;
a sheath impermeable to water;
a polyamide layer overcoating said sheath which is impermeable to gas or oil; and
an outer metal housing positioned over said polyamide layer.

2. The pipe of claim 1 wherein said polyamide layer is polyamide 11.

3. The pipe of claim 1 wherein said sheath is made from a material selected from the group consisting of polyvinylchloride, polyethylene, polyvinyldifluoride and polytetrafluoroethylene.

4. The pipe of claim 1 further comprising an internal metal carcass positioned inside said sheath.

5. A pipe for the transport oil or gas, comprising;
a polyamide sheath which is impermeable to gas or oil;
a chain extender or desiccant incorporated into said polyamide sheath; and
an outer metal housing positioned over said polyamide sheath.

6. The pipe of claim 5 wherein said polyamide sheath is polyamide 11 and said chain extender or desiccant is selected from the group consisting of ethylene glycol, sodium sulfate, magnesium sulfate, and calcium chloride.

7. The pipe of claim 5 further comprising an internal metal carcass positioned inside said polyamide sheath.

8. A pipe for the transport of oil or gas, comprising;
a copolymer polyamide sheath which is impermeable to gas or oil overcoating, said copolymer polyamide sheath being selected from the group consisting of graft copolymers wherein hydrophobic moieties are covalently bonded to a backbone of a polyamide, block copolymers wherein hydrophobic polymer chains are joined with a polyamide, and polymer blends which include mixtures of hydrophobic polymers and polyamides; and
an outer metal housing positioned over said copolymer polyamide sheath.

9. The pipe of claim 8 wherein said copolymer polyamide sheath is a graft copolymer and wherein said hydrophobic moieties are halogens bonded directly to said backbone of said polyamide or halogens bonded to side chains which are bonded to said polyamide.

10. The pipe of claim 8 wherein said copolymer polyamide sheath is a block copolymer and said hydrophobic polymer chains are selected from the group consisting of polyvinylchloride, polyethylene, polyvinyldifluoroethylene, and polytetrafluoroethylene.

11. The pipe of claim 8 wherein said copolymer polyamide sheath is a mixture of hydrophobic polymers and polyamides wherein said hydrophobic polymers are selected from the group consisting of polyvinylchloride, polyethylene, polyvinyldifluoroethylene, and polytetrafluoroethylene.

12. The pipe of claim 8 further comprising an internal metal carcass positioned inside said polyamide sheath.

13. A pipe for the transport oil or gas, comprising;
a polyamide sheath which is impermeable to gas or oil;
a means for heating said polyamide sheath in heat transport connection with said polyamide sheath; and
an outer metal housing positioned over said polyamide sheath.

14. The pipe of claim 13 wherein said means for heating is a plurality of heating elements associated with said polyamide sheath.

15. The piper of claim 13 wherein said means for heating is one or more hot air sources directed over said polyamide sheath.

16. The pipe of claim 13 further comprising an internal metal carcass positioned inside said polyamide sheath.

17. A method for extending the life of a polyamide barrier layer used in a pipe for the transport of oil or gas, comprising the steps of:
incorporating a desiccant into a polyamide material used as a barrier layer in said pipe; and
binding water which diffuses into the polyamide material within said pipe with said desiccant during pumping of oil or gas.

18. The method of claim 17 wherein said incorporating step is performed during extrusion of said polyamide barrier layer.

19. A method for extending the life of a polyamide barrier layer used in a pipe for the transport of oil or gas, comprising the steps of:
incorporating a chain extender into a polyamide material used as a barrier layer in said pipe; and
covalently joining adjacent polyamides in said polyamide material with said chain extender.

20. A method for extending the life of a polyamide barrier layer used in a pipe for the transport of oil or gas, comprising the steps of:
providing a water impermeable sheath on an inner surface of a polyamide material used as a barrier layer in said pipe; and
blocking water from diffusing into the polyamide material within said pipe with said water impermeable sheath during pumping of oil or gas.

21. A method for rejuvenating a polyamide barrier layer used in a pipe for the transport of oil or gas, comprising the step of heating said polyamide barrier layer with a hot dry fluid at a temperature sufficient to drive out water.

22. The method of claim 21 wherein said hot dry fluid is air.

23. The method of claim 21 wherein said hot dry fluid is oil or gas.

24. The method of claim 21 wherein said hot dry fluid contains a desiccant or chain extender.

25. The method of claim 21 wherein said step of heating is performed by injecting said hot dry fluid at a first end of said pipe, and wherein said hot dry fluid has a heat capacity sufficient to allow adequate heating over an entire length of the polyamide barrier layer to a second end of said pipe.
